(19) United States
(12) Patent Application Publication
(10) Pub. No.: US 2012/0016738 A1
(43) Pub. Date: Jan. 19, 2012

(54) Performance based pricing, promotion, and personalized offer management

(75) Inventor: Kenneth J. Ouimet, Scottsdale, AZ (US)

(73) Assignee: My World, Inc.

(21) Appl. No.: 12/806,951

(22) Filed: Aug. 24, 2010

Related U.S. Application Data
(63) Continuation-in-part of application No. 12/804,272, filed on Jul. 15, 2010.

(51) Int. Cl. G06Q 30/00; G06Q 90/00

(52) U.S. Cl. 705/14.46; 705/500; 705/14.49; 705/14.69

(57) ABSTRACT

Techniques for conducting a promotion of a product or service, managing various promotion activities, and rewarding promotion partners are disclosed. An incremental sales (e.g., incremental sales volume, revenue, and profit) analysis due to a promotion is performed and a fee is assessed based on a result of the incremental sales analysis. In some embodiments, performing the incremental analysis includes assigning to a control group a first subset of a plurality of target customers associated with the promotion, assigning to an offer group at least a second non-overlapping subset of the plurality of target customers, providing to at least the offer group but not to the control group an offer associated with the promotion, and determining an incremental change in sales of the product contributed by the customers in the offer group—as compared to sales contributed by the customers in the control group. In some embodiments, performing the incremental sales due to the promotion is determined based on a difference between a maximum allowable discount and an actual discount for individual customers.

### CROSS REFERENCE TO OTHER APPLICATIONS

This application is a continuation in part of co-pending U.S. patent application Ser. No. 12/804,272 entitled PERFORMANCE BASED TRADE PROMOTION PRICING filed, Jul. 15, 2010, which is incorporated herein by reference for all purposes.

### BACKGROUND OF THE INVENTION

Advertisers such as manufacturers and retailers traditionally used mass marketing vehicles such as newspaper, television and radio to promote their products. These advertisements are in general expensive and advertisers often take a huge gamble since the pricing of an advertisement often does not reflect sales results achieved. To reduce the risks associated with promotion, various semi performance based promotion pricing models have been developed. Under the cost-per-thousands (CPM) model, advertisers are charged based on impressions or how many people viewed the advertisement. However using this model, the advertiser is charged even if the individual may not have even seen or been aware of the advertisement. This problem is overcome using the cost-per-click (CPC) model in which advertiser is charged when an individual clicks on the advertisement. However using this model, the advertiser is still charged even if the individual does not purchase the product. Even with the cost-per-lead (CPL) model, a pricing model currently considered being one of the most advertiser friendly pricing models and sitting at the pinnacle of online advertising return-on-investment (ROI) hierarchy in which advertisers only pay for qualified leads, the advertisers are still left to pay for leads that do not result in sales and take on significant return-on-investment (ROI) risk due to uncertain conversion rate. In addition to the ROI risk, current pricing models also do not address various other risks to advertisers, including causality risk since it is unclear without the advertisement whether a buyer would not have bought the product, and cannibalization risk since an advertisement or promotion may help to sell one product but at the expense of cannibalizing the sales of another product sold by the same company. Thus an improved promotion pricing model for rewarding promotion partners that is truly based on performance of the promotion is needed to reduce financial risks to individuals or entities promoting their products or services.

Furthermore, it is often difficult to accurately measure the performance of a promotion event or activity because of a lack of effective metrics. This may lead to suboptimal management of promotion partners, promotion activities and/or events such as merchandise pricing and offer generation, particularly personalized offer generation. Traditionally, promotion performance has been measured in terms of incremental increases in total promotion sales over a baseline total sales, such as a forecast of total sales in the absence of the promotion calculated based on historic data. However, this approach is not necessarily reliable, since the customers used for measuring the baseline sales and the promotion sales are different, it is not always certain whether and how much of the measured difference in sales is due to the difference in the types of customers and how much of the measured difference in sales is actually due to the promotion. Further since sales data from different time periods are used, it is not always easy to separate out incremental change in sales due to external factors or events that occur during one of the promotion period or baseline period but not during the other from incremental change in sales due to promotion. Thus improved methods for accurately measuring promotion performance, managing various promotion activities such as merchandise pricing, offer generation, particularly personalized offer generation are needed.

### BRIEF DESCRIPTION OF THE DRAWINGS

Various embodiments of the invention are disclosed in the following detailed description and the accompanying drawings.

FIG. 1 is a block diagram of an embodiment of a system for implementing promotion of product in accordance with an embodiment of the invention.

FIG. 2 is a schematic diagram of an example POS terminal of a physical store in accordance with an embodiment of the invention.

FIG. 3 is a flowchart of a process for conducting a promotion of a product in accordance with an embodiment of the invention.

FIG. 4 is a flowchart of a process for measuring the performance of a promotion.

FIG. 5 illustrates an embodiment of a process for determining control groups and offer groups for the plurality of promotions.

FIG. 6 is a flowchart of a process for measuring the performance of a promotion of a product by comparing an incremental change in sales (e.g., incremental change in sales volume, revenue and/or profit) to the offer group during a promotion period to an incremental change in sales to the control group during the promotion period.

FIG. 7 is a flowchart of a process for measuring the performance of a promotion of a product based on a maximum allowable offer.

FIG. 8 illustrates a spreadsheet .used in some embodiments to track assignment to control and offer groups.

FIG. 9 illustrates a spreadsheet used in some embodiments to track assignment to control and offer groups.

FIG. 10 illustrates a spreadsheet used in some embodiments to track purchase transaction information relating to a promotion of a product.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured. The term product used herein includes tangible products and intangible products such as services.

Techniques for conducting promotion, managing various promotion activities and rewarding promotion partners are disclosed. In some embodiments, a new promotion performance measurement model that employs a dynamic control group that includes a plurality of customers randomly selected from a group of target customers is used. In some examples, <50% of a group of target customers may be randomly selected and assigned to the control group that do not receive promotion offers and the remaining target customers are assigned to the offer group that receive promotion offers. In some embodiments, the sales to the customers of the offer group and control group are tracked and the promotion performance is measured in terms of the difference in sales to the offer group and the control group. In some embodiments, a plurality of products is promoted and for each of the plurality of products, a different control group is created by randomly selecting and assigning a different portion of the same pool of target customers to the control group for that product and assigning the remaining portion of the pool of target customers to an offer group for that product. In some embodiments, only a small percentage of the pool of target customers are assigned to each control group, so that the same pool of target customers can be used to measure the promotion performance for a plurality of products without significantly affecting each customer's ability or chance for receiving the promotion offers.

In some embodiments, a promotion performance measurement model that does not require a control group is used to measure the performance of a promotion. In this model, the performance of a promotion is measured by calculating the sum of the difference between a maximum allowable offer that can be offered to customers and the actual offers given to the customers that have enticed the customers to purchase the product for each target customers of a pool of target customers.

In some embodiments, the measured performance of a promotion is used to reward promotion partners and managing various promotion activities of the promotion. A fee determined based on the measured promotion performance may be paid to one or more promotion partners that participate or otherwise contribute to the promotion.

In some embodiments, an incremental analysis of sales (e.g. incremental analysis of change in sales volume, revenue, and/or profit) attributable to the promotion is performed, and a fee is set and assessed based on the result of the incremental sales analysis, such as based on a percentage of the incremental change in sales. In some embodiments, the incremental change in sales is determined by comparing an incremental change in sales (e.g., incremental change in sales volume, revenue and/or profit) to the offer group during a promotion period to an incremental change in sales to the control group during the promotion period. In some embodiments, the incremental change in sales such as incremental change in sales revenue or profit is measured based on a maximum allowable offer of a product. In some embodiments, a dynamic control group is used to measure the incremental change in sales. In some embodiments, the fee is assessed against an advertiser who pays for the planning and/or execution of the promotion for promoting its product. The advertiser may be any enterprise and/or individual such as a manufacturer, retailer, distributor, wholesaler, supplier and/or promoter of the product. The fee assessed may be paid to one or more promotion partners that participate or otherwise contribute to the planning and/or execution of the promotion. The promotion partners may include one or more retailers that sell the product to individual customers, distributors and wholesalers that distribute the product to retailers, and/or publishers/promoters of the promotion product that generate and/or communicate the product promotion offers to individual customers or other buyers of the product.

In some embodiments, measuring the performance of a promotion includes measuring an incremental change in sales of a product attributable to the promotion of the product. In some embodiments, measuring the performance of a promotion includes measuring an incremental change in sales of a second product due to the promotion of a first product. In some embodiments, the second product is a competing product, a substitutable product of the first product, and/or any product sales of which is affected by the promotion. In some embodiments, the first product and the second product are products of a single entity (e.g., a single manufacturer) and the measured performance of the promotion can be used to identify and/or measure cannibalization of the second product as a result of promoting the first product. In some embodiments, measuring the performance of a promotion includes measuring an incremental change in sales for a plurality of products due to the promotion including the promotion of a first product. In some embodiments, the plurality of products includes the promoted first product. In some embodiments, the plurality of products does not include the promoted first product. In some embodiments, the plurality of products are products of a single entity (e.g., a single manufacturer) and the measured performance of the promotion can be used to identify and/or more measure product cannibalization of one or more of the plurality of products as a result of promoting the first product, and/or used to measure an overall sales impact on one or more of the plurality of products of the entity as a result of promoting the first product. In some embodiments, the pluralities of products are products of a single entity and are identified to be included in a promotion performance measurement group, and the sales performance (e.g., measured by incremental change in sales) of the products in the group is used to set pricing for rewarding promotion partners (e.g., publisher and retailer) to ensure that the promotion is managed in such a way that the group of products as a whole performs the best, for example to make sure that a publisher generates offers such as individualized offers to customers in a way to maximize the sales performance of the entire group of products.

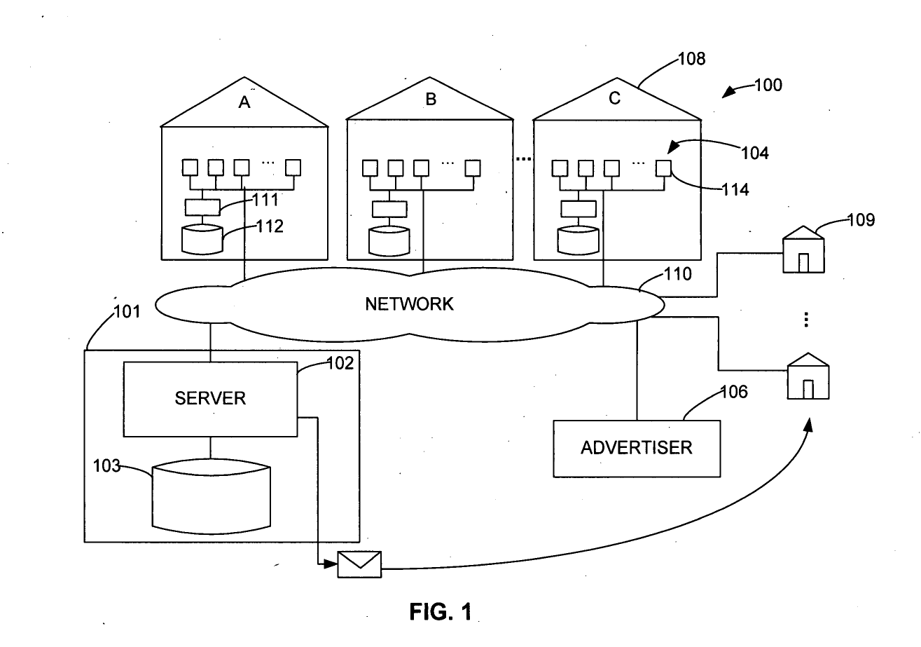

FIG. 1 is a block diagram of an embodiment of a system 100 for implementing promotion of product in accordance with an embodiment of the invention. The product herein may encompass tangible product as well as intangible product such as service. System 100 includes a publisher computer system 101 connected to one or more point-of-sale (POS) systems 104 of one or more retailers 108 that sell the product to customers, advertiser 106 computer systems, and a plurality of customers 109 participating in the promotion via communication links established by a network 110. The publisher computer system 101 is shown to include a server 102 which may consist of one or more processors and one or more data storage devices and/or systems 103. The processors and the storage devices and/or systems associated with the server 102 may be located in a single location or distributed in geographically diverse locations. Retailers 108 may include one or more physical stores and/or virtual online stores. Each of the POS systems 104 may include a plurality of POS terminals 114. The network 110 may include various communications networks, wired or wireless.

The term advertiser herein may encompass any enterprise/individual on behalf of which a product is promoted. The advertiser usually pays for the planning and/or execution of the promotion. An advertiser may for example be a vendor, a retailer, a wholesaler, a distributor, or a manufacturer that wants to promote its product(s) through the promotion. The term publisher herein may encompass any enterprise/individual that participates in the promotion by performing various activities associated with the promotion other than the actual selling of the product, including for example generating promotion offers, communicating the promotion offers to the customers, and/or analyzing the performance of the promotion. In some embodiments, the publisher and the retailer can be one entity, in such situations a retailer that sells the product is also the publisher that communicates the promotion offers to the customers and perhaps generates the offers.

The server 102 is configured to perform various processes associated with promotion of one or more products, including determining the performance of the promotions and/or assessing a fee such as automatically assessing a fee based on the determined performance. The fee can be assessed against for example one or more enterprises/individuals on behalf of which the promotion is conducted, such as against a manufacturer. In some embodiments, for each promotion conducted, the server 102 is configured to assign such as randomly assign a plurality of target customers to a first group and a second group, where each of the target customers in the second group is offered a promotion of the product and the target customers in the first group are not offered the promotion of the product.

The server 102 may be configured to generate and/or communicate promotion offers to the target customers participating in a promotion. The offers may be generated based on various promotion parameters received, such as promotion budget, a maximum allowable promotion offer or discount, the target customer demographic group, and/or the target customer. The offers may be individualized to each customer or each customer demographic group. Each of the promotion offers may be assigned an identifier identifying the type of offer. The identifier may also identify the customer receiving the offer. In some embodiments the identifier may identify each of the target customers as belonging to a group such as a promotion group (e.g., control group and offer group) or a customer demographic group. In some embodiments, the identifier associated with the offer may uniquely identify each of the customers receiving the offer.

In some embodiments the server 102 is configured to receive purchase transaction information relating to a promotion, for example from a plurality of point-of-sales systems 104, and determine a performance of the promotion (e.g., determine incremental sales attributable to the promotion) based on the purchase transaction information received. In some embodiments, the server 102 is further configured to communicate the determined performance to a third party (e.g., advertiser 106, a retailer 108) who benefits from the improved performance of the promotion and/or on behalf of whom the promotion is conducted and automatically assess a fee against the third party based on the determined performance. In one example, a fee equals to 3% of the determined incremental increase in profit of a product is charged against a manufacture of the product.

The POS systems 104 may be configured to identify the promotion offer, the target customer, and/or the customer demographic group. In some embodiments, the promotion offer, the target customer, the customer demographic group and other customer profile information may be identified when a customer swipes his/her loyalty card at a POS system. In some embodiments, the promotion offer and the target customer may be identified when an identifier included in the promotion offer to the customer is scanned in or otherwise entered at the POS system. The customer demographic and other profile information associated with the customer can be pulled up from a computer storage once the customer is identified.

The POS system 104 may be configured to process purchase transactions relating to the promotion, record the purchase transaction information, and communicate the purchase transaction information to the server 102 for performance analysis. The information gathered may include retail store identifiers uniquely identifying the stores or groups of stores where the target customers purchase the promoted products. It may include customer identifiers identifying the target customers. The customer identifiers may identify whether the target customers belong to a promotion group (e.g., a control group or an offer group), and/or uniquely identifying each customer purchasing the promoted product/service. The information gathered may also include a description of the products purchased, the price and quantity of the purchase, and the time and dates of the purchases. The information gathered may also identify the type promotional discount or a lack of promotional discount being redeemed by the customer. The purchase transaction information may be gathered via various methods, such as scanning or otherwise entering an identifier associated with the promotion offer, a customer identifier, credit card, debit card, loyalty card, biometrics, and/or government identification.

The manufacturer 106 computer system may be configured to send parameters of a promotion to the server 102 and/or to the various POS systems to guide the planning and execution of the promotion. The various parameters may include for example, promotion budget, promotion period, and maximum allowable offer. The manufacturer 106 computer system may be configured to receive a determined performance of a promotion of a product and use it to adjust its promotion strategy for the product. Details are discussed below.

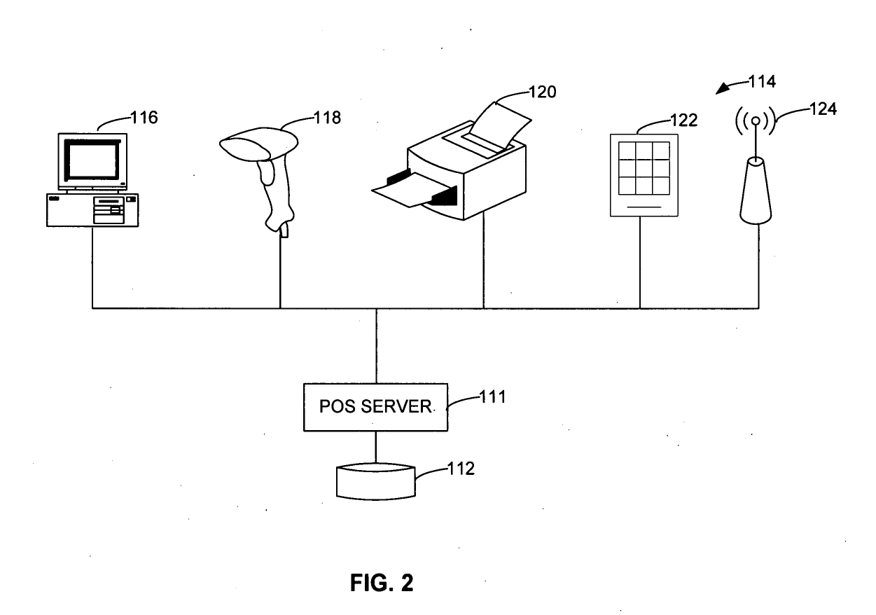

FIG. 2 is a schematic diagram of an example POS terminal 114 of a physical store in accordance with an embodiment of the invention. The POS terminal 114 includes a computer terminal 116 for processing sales transactions, an optical bar code scanner 118 for scanning product or promotion offer UPC codes, a printer 120 for printing promotion coupon at the point-of-sales, a magnetic strip reader with a keypad 122, and a wired/wireless interface 124 for communicating with the network 110. The magnetic strip reader can be used to read credit card, debit card, smart card, and/or various other financial or customer identification cards. The keypad can be used for manually inputting information, such as for manually entering customer identifiers and promotion offer identifiers. The purchase transaction information collected by the POS terminals 114 may be stored in local data storages 112 associated with the POS systems and/or stored in data storages associated with a centralized server (e.g., Server 102 of FIG. 1).

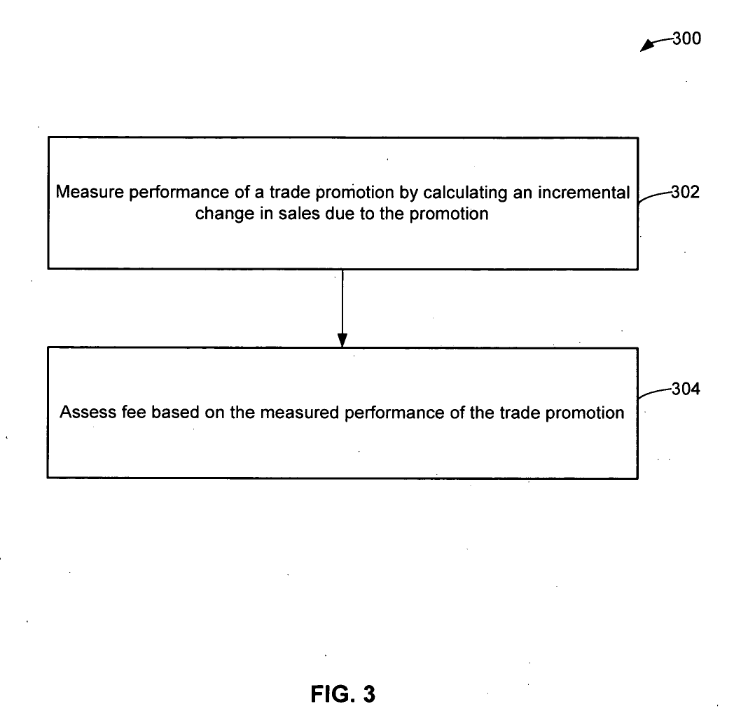

FIG. 3 is a flowchart of a process 300 for conducting a promotion of a product in accordance with an embodiment of the invention. At 302, the performance of a promotion is determined by calculating an incremental change in sales (also termed as incremental sales) attributable to or resulted from the promotion. The incremental change in sales can be measured in various ways, such as incremental change in sales volume, revenue and/or profit such as gross profit, net profit, and/or various other types profit measurement. The promotion performance can be measured for a customer demographic group, such as customers associated with one or more retailers, distributors, wholesalers, and/or a type of promotion offer, by using control group and offer group assigned from target customers belonging to that group. The measured performance can also be used to adjust future promotion strategy. For example, the most profitable customer demographic groups, retailers, distributors, and wholesalers can be identified to receive future promotions of the product/service. The most profitable types of offers can be used in future promotions. Product promotion that will generate an overall positive financial gain (e.g., for a manufacturer, retailer, distributor, or wholesaler) will be identified for promotion in the future. For example, taken into consideration of the effects on all related products (e.g., taken into consideration of cannibalization of competing products) of a manufacturer, a product promotion of which generates, in some embodiments, an overall positive incremental change in sales volume, revenue, and/or profit for all of the competing products of the manufacturer will be identified for promotion in the future.

At 304, a fee is assessed based on the measured performance of the promotion. The fee assessed may be based on a percentage of the incremental change in sales. In some embodiments, the fee is assessed against an advertiser, an enterprise and/or individual such as a manufacturer, retailer, distributor, wholesaler, supplier and/or promoter of the product that pays for the planning and execution of the promotion for promoting its product. The fee assessed may be paid to one or more enterprises/individuals that participate in or otherwise contribute to the planning and/or execution of the promotion, such as retailer(s), distributor(s), wholesaler(s), and/or publisher(s)/promoter(s) of the promotion product. In one embodiment, a retailer may participate in a promotion event by displaying the product or service target of the promotion in a prominent way. The retailer may be rewarded a fee based on the measured performance of the promotion. In another embodiment, a publisher may participate in a promotion event by generating and communicating effective offers such as personalized offers to customers. The publisher may be rewarded a fee based on the measured performance of the promotion. In one embodiment, a fee equals to 3% of an incremental change in sales due to a promotion is charged to the manufacturer of the product. The fee includes 2% paid to the retailer that participates in the promotion by displaying and actually selling the product, and 1% paid to a publisher that generates and communicates offers to individual customers, gathering purchase transaction information, and calculating the incremental change in sales due to the promotion. This performance based pricing model allows the interests of various parties participating in the promotion to be aligned with that of the advertiser/seller, since the parties participating in the promotion share with the advertiser/seller in the actual incremental increase in sales of the product. For example, a publisher/promoter is responsible for creating and communicating promotion offers such as personalized offers of a product to customers and the publisher/promoter may be rewarded a percentage of the incremental change in sales profit attributable to the promotion by the manufacturer. A retailer displays and sells the product in its store and the retailer may be rewarded a percentage of the incremental change in sales profit attributable to the promotion by the manufacturer. Since the reward is based on the incremental changes in sales, the interests of all of the promotion partners participating in the promotion will be aligned with the manufacturer.

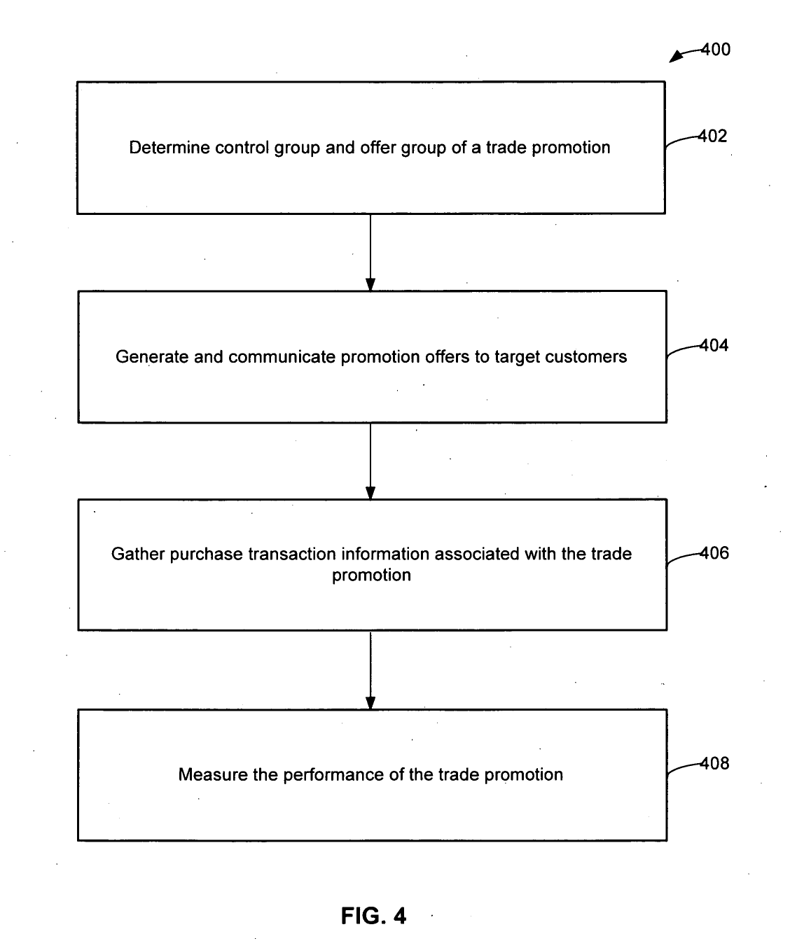

FIG. 4 is a flowchart of a process 400 for measuring the performance of a promotion. At 402, a control group and an offer group are determined for the promotion. In some embodiments a portion of a pool of target customers considered to be at least potential targets of the promotion are assigned to the control group and does not receive the promotion offer. The remaining target customers in the pool are assigned to the offer group and offered to receive the promotion offer. In some embodiments a portion of a pool of target customers considered to be at least potential targets of the promotion are randomly assigned to the control group and does not receive the promotion offer. The remaining target customers in the pool are assigned to the offer group and offered to receive the promotion offer. In some embodiments, 5 to 20% of a pool of target customers is assigned to the control group and the remaining 95 to 80% of the pool of target customers is assigned to the offer group. In one embodiment, 10% of a pool of target customers is assigned to the control group and the remaining 90% of the pool of target customers is assigned to the offer group. In some embodiments, the pool of target customers may belong to a particular group, such as a particular demographic group, retailer, distributor and wholesaler, and/or a group of retailers, distributors and wholesalers.

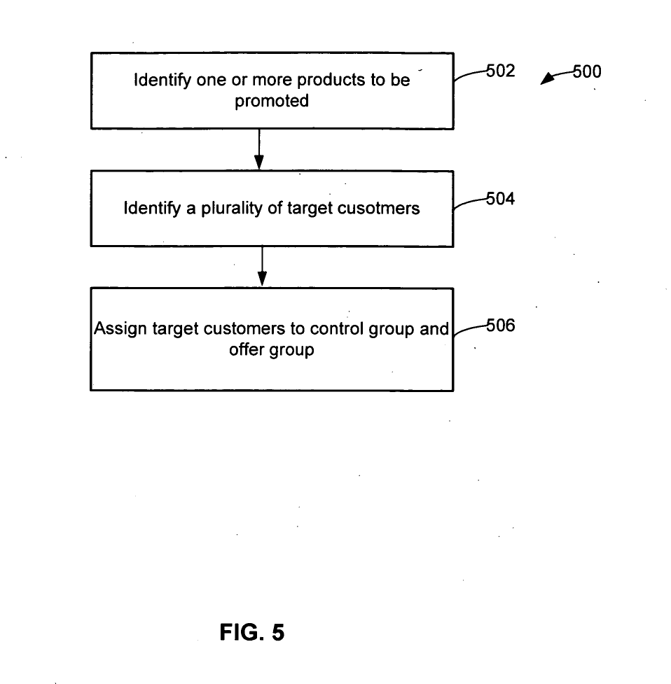

In some embodiments, a plurality of products are promoted and where the promotion of the plurality of products shares the same target customer pool, has an overlapping target customer pools, and/or has an overlapping promotion time periods. FIG. 5 illustrates an embodiment of a process for determining control groups and offer groups for the plurality of promotions. At 502, one or products to be promoted are identified. At 504, a plurality of target customers for the promotion of the one or more products is identified, for example from the customer pools of one or more retailers participating in the promotion.

At 404, promotion offers are created and communicated to the target customers in the offer group. The promotion offers may be in various forms, such as discount, coupon, and rebate. In some embodiments, the promotion may comprise a set of personalized offers that differ among members of the offer group. Each offer may be assigned an identifier. In some embodiments the identifier may identify whether the target customers belong to a promotion group (e.g., a control group or an offer group), and/or uniquely identifying each customer purchasing the promoted product/service. The offers may be communicated via direct mail, email, phone message, text message, and/or point-of-sale print-out system.

At 406, purchase transaction information associated with the promotion is gathered. The purchase transaction information relating to the promotion period sales to the control group and to the offer group can be obtained for example from various POS systems. At least a subset of the purchase transaction information may be obtained by scanning or otherwise entering an identifier associated with the promotion offers, customer identifier, credit card, debit card, loyalty card, biometrics, and/or government identification. The transaction information gathered may include one or more identifiers identifying the purchase and the customer, include retail store identifiers uniquely identifying the stores or groups of stores where the target customers purchase the promoted products. It may include customer identifiers identifying the target customers. The customer identifiers may identify whether the target customers belong to a promotion group (e.g., a control group or an offer group), and/or uniquely identifying each customer purchasing the promoted product/service. The transaction information may also include a description of the products purchased, the price and quantity of the purchase, and the time and dates of the purchases. The transaction information may also identify the type promotional discount or a lack of promotional discount being redeemed by the customer. The transaction information may include transaction information of various products relating to the promoted product (e.g., competing products of the promoted products) that are purchased by the offer group and control group during the promotion period and/or during a period no promotion of the product is carried out. In some embodiments, the related products and the promoted product are products of a single entity, such as a single manufacturer, retailer, distributor, and/or wholesaler.

At 408, measure the performance of the promotion by determining an incremental change in sales attributable to the promotion. In some embodiments, the incremental change in sales is determined by comparing an incremental change in sales (e.g., incremental change in sales volume, revenue and/or profit) to the offer group during a promotion period to an incremental change in sales to the control group during the promotion period. The incremental sales to offer group is computed by comparing promotion period sales to the offer group to baseline sales to the offer group. The incremental sales to control group is computed by comparing promotion period sales to the control group to baseline sales to the control group. In some embodiments, historic sales of individual target customers and/or groups of customers are maintained for one or more product(s) and/or product categories and the historic sales data is used to establish baseline sales of the target customers for the one or more product(s). In some embodiments, incremental sales to a target customer or group (either control or offer) are determined by comparing sales to the customer (or group) during the offer period associated with a promotion to baseline sales to the customer (or group) during a period no promotion is conducted. In some embodiments, calculating an incremental change attributable to the promotion includes calculating an incremental change in sales of the product being promoted that is attributable to the promotion of the product. In some embodiments, calculating an incremental change in sales attributable to the promotion includes calculating an incremental change in sales of a second product attributable to the promotion of a first product. The second product in some embodiments is a competing product of a first product. In some embodiments, calculating an incremental change attributable to the promotion includes calculating an incremental change in sales for a plurality of products due to the promotion of a product. In some embodiments, the plurality of products includes the promoted product. In some embodiments, the plurality of products does not include the promoted product. In some embodiments, the plurality of products are products of a single entity (e.g., products of a single manufacturer) and the calculated incremental change in sales of the promotion can be used to identify and/or more measure product cannibalization of one or more of the plurality of products as a result of promoting .the first product, for example when the incremental change in sales of one or more products that are not the subject of the promotion decreased as the incremental change in sales of the promoted product increased as a result of the promotion activity, and/or used to measure an overall sales impact on one or more of the plurality of products of the entity as a result of promoting the promoted product.

In some embodiments, the incremental change in sales such as incremental change in sales revenue or profit can be measured based on a maximum allowable offer of a product. The maximum allowable offer may be in the form of a maximum discount per unit of product sold. The maximum allowable offer may be set by an advertiser/seller of the product based on for example the cost per unit of product and/or the desired minimum profit per unit of product. In some embodiments the performance of a promotion of a product is calculated based on a difference between a maximum allowable offer of the product and actual offer(s) of the product to the target customers of the promotion. The actual offer(s) may be individualized or personalized offers to individual customers.

FIG. 5 illustrates an embodiment of a process for determining control groups and offer groups for the plurality of promotions. At 502, one or products to be promoted are identified. At 504, a plurality of target customers for the promotion of the one or more products is identified, for example from the customer pools of one or more retailers participating in the promotion. At 506, for each product being promoted during a promotion period, assign (e.g., randomly assign) a first portion of the target customers into a control group and a second portion that does not overlap the first portion to an offer group. The customers in the control group do not receive the promotion offers for the product while the customers in the offer group will receive the promotion offer. In some embodiments, 10% of the target customers are randomly assigned to the control group and the remaining 90% of the target customers are assigned to the offer group for each product during a promotion period. In some embodiments, <25% of the target customers are randomly assigned to the control group and the remaining customers are assigned to the offer group for each product during the promotion period. In some embodiments, <50% of the target customers are randomly assigned to the control group and the remaining customers are assigned to the offer group for each product during the promotion period, In some embodiments, a target customer assigned to a first control group for a first product or product category, for example, may not be included in a second control group for a second product or product category, and as a result may not receive a first promotion associated with the first product or product category, while remaining during the same and/or an overlapping period eligible to receive a second promotion associated with the second product or product category. In this way, a target customer assigned to a control group receives at least some offers even during a period in which the target customer is assigned to a control group. In some embodiments, a target customer assigned to a first control group for a product or product category during a first promotion period, for example, may not be included in a second control group for the same product or product category during a second promotion period, and as a result may not receive a first promotion associated with the product or product category during the first promotion, while remaining during the second promotion period eligible to receive a second promotion associated with the same product or product category. In this way, a target customer may not feel any significant impact of the promotion and can thus be repeatedly used for promotion of different products and during different promotion periods. Similarly, a pool of customers can be used repeatedly for promotions of different products and/or during different promotion periods.

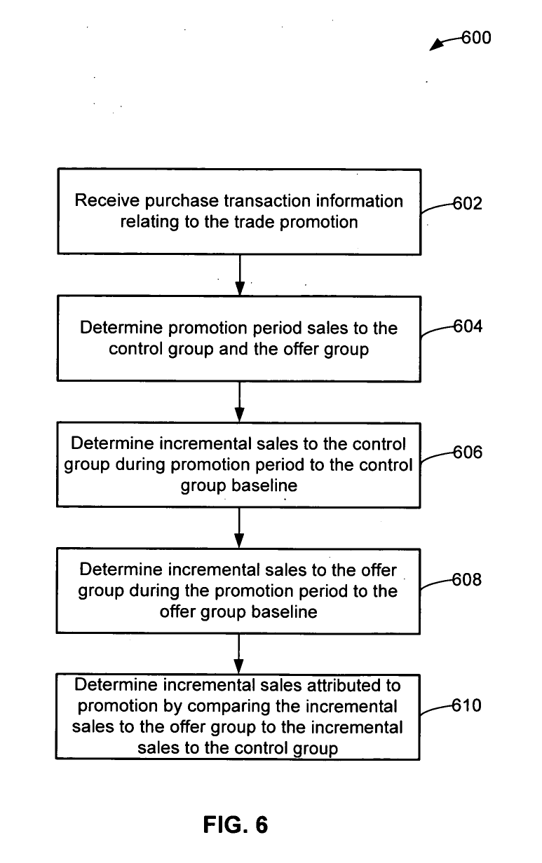

FIG. 6 is a flowchart of a process 600 for measuring the performance of a promotion of a product by comparing an incremental change in sales (e.g., incremental change in sales volume, revenue and/or profit) to the offer group during a promotion period to an incremental change in sales to the control group during the promotion period. At 602, purchase transaction information relating to the promotion is received from for example a plurality of POS systems. The transaction information gathered may include one or more identifiers identifying the purchase and the customer, include retail store identifiers uniquely identifying the stores or groups of stores where the target customers purchase the promoted products. It may include customer identifiers identifying the target customers. The customer identifiers may identify whether the target customers belong to a promotion group (e.g., a control group or an offer group), and/or uniquely identifying each customer purchasing the promoted product/service. The transaction information may also include a description of the products purchased, the price and quantity of the purchase, and the time and dates of the purchases. The transaction information may also identify the type promotional discount or a lack of promotional discount being redeemed by the customer. At 604, the promotion period sales to the control group and to the offer group are determined based on the purchase transaction information. In some embodiments, promotion period sales to the control group and to the offer group include sales information of the product being promoted and the sales information of related products (e.g., competing products of the promoted products). At 606, incremental sales to the control group are computed by comparing the promotion period sales to control group to the baseline sales to the control group. In some embodiments, incremental sales of the promoted product to the control group are calculated. In some embodiments, incremental sales of products related to the promoted product (e.g., competing products) to the control group are calculated. At 608, incremental sales to offer group is computed by comparing promotion period sales to the offer group to baseline sales to the offer group. In some embodiments, incremental sales of the promoted product to the offer group are calculated. In some embodiments, incremental sales of products related to the promoted product (e.g., competing products) to the offer group are calculated. In some embodiments, historic sales of individual target customers and/or groups of customers are maintained for one or more product(s) and/or product categories and the historic sales data is used to establish baseline sales of the target customers for the one or more product(s). In some embodiments, incremental sales to a target customer or group (either control or offer) are determined by comparing sales to the customer (or group) during the offer period associated with a promotion to baseline sales to the customer (or group) during a period no promotion is conducted. The incremental sales can be measured in various ways, such as in terms of incremental change in sales volume, revenue and/or profit. In some embodiments, the sales contributed by each customer are compared to the baseline sales of the same customer. In some embodiments, the sales contributed by a demographic group are compared to the baseline sales of the same demographic group. At 610, compare incremental sales to offer group to incremental sales to control group to determine incremental sales attributed to promotion, which is a measure of the promotion performance. In some embodiments, incremental sales of the promoted product to the offer group are compared to the incremental sales to the control group to determine incremental sales attributed to the promotion. In some embodiments, incremental sales of products related to the promoted product (e.g., competing products) to the offer group are compared with the incremental sales of the related products to the control group to determine incremental sales attributed to, the promotion. In some embodiments, the promotion performance can be measured for different groups, such as different demographic groups, retailers, groups of retailers, distributors, wholesaler, and/or promotion offers, by using control group and offer group assigned from customers belonging to such a group.

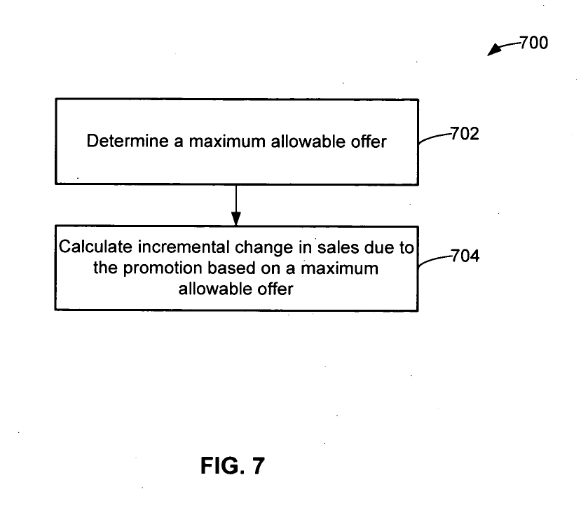

FIG. 7 is a flowchart of a process 700 for measuring the performance of a promotion of a product based on a maximum allowable offer. At 702, a maximum allowable offer is determined. The maximum allowable offer may be set by and communicated from the advertiser such as a manufacturer who pays for the planning and/or execution of the promotion. The maximum allowable offer may be determined based on various promotion parameters such as a promotion budget, and/or a minimum profit desired. At 704, the incremental change in sales (e.g., incremental change in sales revenue or profit) of the promoted product is calculated based on the maximum allowable offer.

In some embodiments, the incremental change in sales the promoted product is calculated using the following equations:

$$Δπ = {S}_{o} * ( \frac{{π}_{o}}{{S}_{o}} - \frac{{π}_{c}}{{S}_{c}} )$$

πₒ=Σ_{x∈o}uₓ(d^{max}−dₓ)

π_{c}=Σ_{x∈c}uₓ(d^{max})

Where πₒ is the profit or revenue for the offer group and is calculated by taking the sum of profit or revenue for all individual transactions in the offer group; uₓ (d^{max}−dₓ) is the profit or revenue for a unit of product sold and is a function of the difference between the maximum allowable discount per unit of product set, d^{max}, and an actual discount for a unit of product, dₓ. In some embodiments, the actual offers are identical to each customer. In some embodiments, the actual offers are individualized for each customer. In some embodiments, the actual offers are individualized for each customer demographic group. π_{c} is the profit or revenue for the control group and is calculated by taking the sum of profit or revenue for all individual transactions in the control group; uₓ(d^{max}) is the profit or revenue for a unit of product sold and is expressed a function of the maximum allowable discount per unit of product set for example by the advertiser, d^{max}; Sₒ is the number of shoppers in the offer group and S_{c} is the number of shoppers in the control group.

In some embodiments, the promotion performance is determined without the use of a control group and is calculated based on a maximum allowable offer (e.g., discount) of the product, set for example by the advertiser, and the actual offers (e.g., discounts) to individual customers. In some embodiments, the incremental change in sales Δπ resulted from the promotion is calculated using the following equation:

Δπ=Σ_{x∈o}(d^{max}−dₓ)

where (d^{max}−dₓ) is the difference between the maximum allowable discount per unit of product (e.g., set by the advertiser), d^{max}, and the actual discount, dₓ, for each transaction associated with the promotion. Δπ is calculated by taking the sum of (d^{max}−dₓ) for all units of the product sold during the promotion period. The underlying assumption of this approach is that all or substantially all units of the product that can be sold at the maximum allowable discount, d^{max}, are sold, and each unit is sold at an actual discount, dₓ, which can be different for different customers or customer demographic group and which is equal to or lower than the maximum allowable discount, d^{max}.

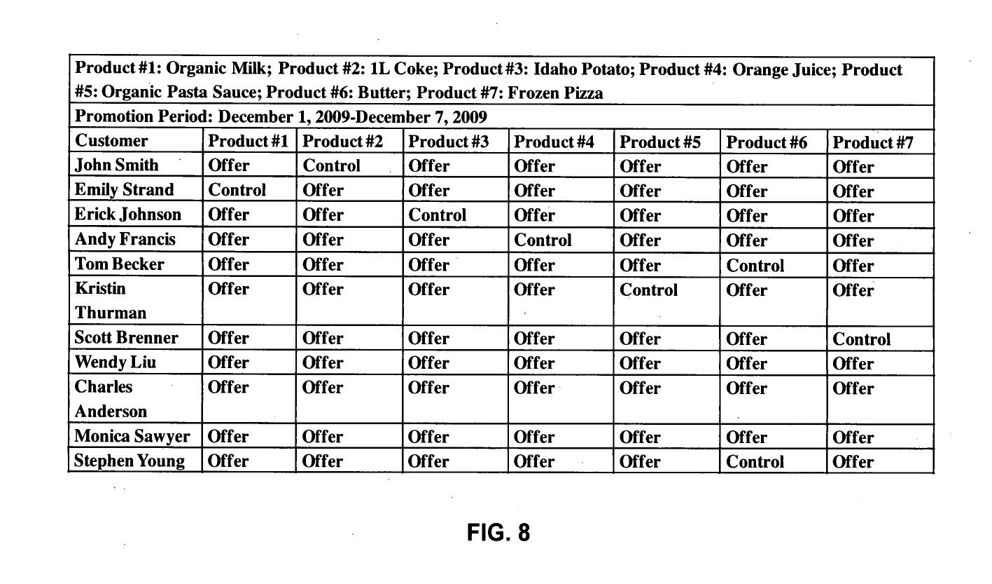

FIG. 8 illustrates a spreadsheet used in some embodiments to track assignment to control and offer groups. In the example shown, target customers have been assigned randomly to control and offer groups for different product promotions during a promotion period. A customer who is assigned to a control group for one product may be assigned to an offer group for other products during the same promotion period. For example, Customer “John Smith” is assigned to a control group for product #2 and assigned to offer groups for other products during the promotion period starting on Dec. 1, 2009 and ending on Dec. 7, 2009.

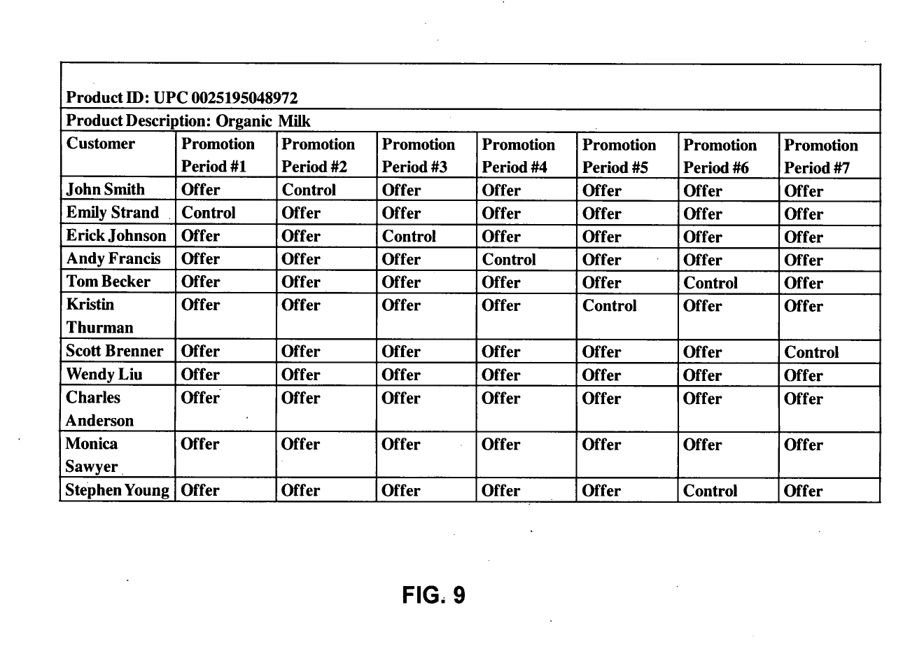

FIG. 9 illustrates a spreadsheet used in some embodiments to track assignment to control and offer groups. In the example shown, for the product indicated, i.e., organic milk have the UPC indicated, target customers have been assigned to control and offer groups for that product during different promotion periods. A customer who is assigned to a control group during one promotion period may be assigned to an offer group during another promotion period. For example, Customer “John Smith” is assigned to a control group during promotion period #2 and is assigned to offer groups during other promotion periods.

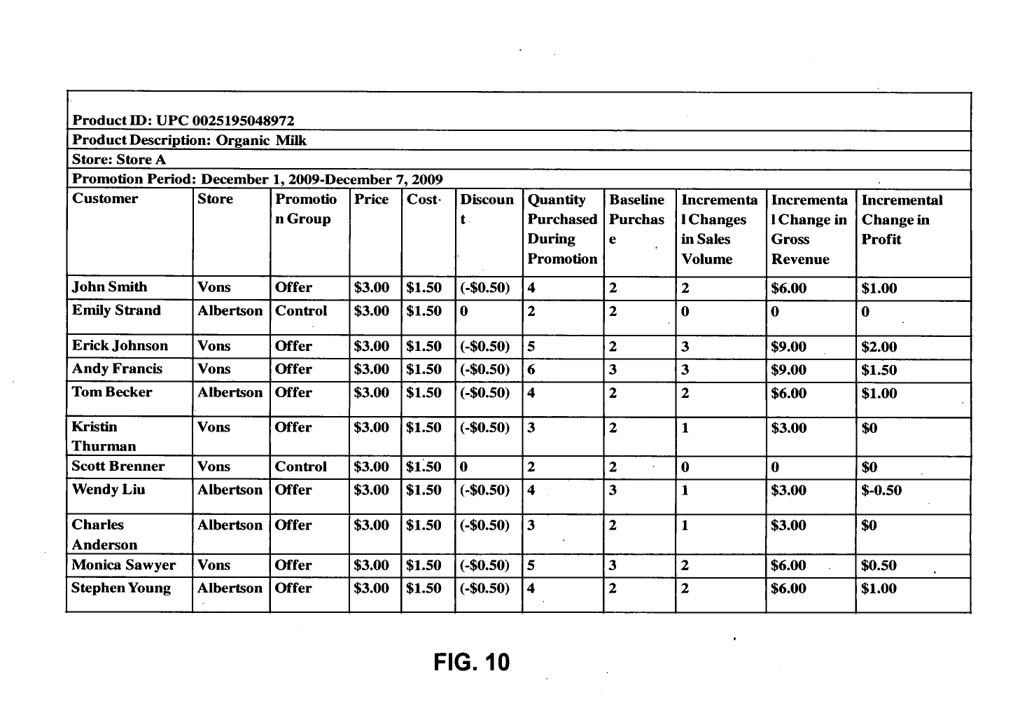

FIG. 10 illustrates a spreadsheet used in some embodiments to track purchase transaction information relating to a promotion of a product. The purchase transaction information may be received from a plurality of POS systems 104 and stored in the data storage 103 of the server 102 of FIG. 1. In the example shown, members of the offer group received the same offer ($0.50 discount), but in various embodiments individualized or subgroup specific offers at different levels, for example different levels of discount, may be made to members or groups within the offer group. Incremental sales data may be calculated and used (e.g., by manufacturer) to adjust future promotion strategy. For example, the calculated incremental change in profit shows that customers “John Smith”, “Erick Johnson”, “Andy Francis”, “Tom Becker”, “Monica Sawyer”, and “Stephen Young” all generated incremental increase in profits, and Store A customers generated higher incremental increase in profits than Store B customers. This information may be communicated to the manufacturer and used to adjust its promotion strategy, for example to determine which product promotion is the profitable and who are the most profitable customers and/or stores that should be selected to participate in future promotion of the product.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
performing an incremental sales analysis due to a promotion; and
assessing a fee based on a result of the incremental sales analysis.

2. The method of claim 1, wherein the method is a method for managing pricing.

3. The method of claim 1, wherein the method is a method for managing promotion.

4. The method of claim 1, wherein the method is a method for managing personalized offers to customers.

5. The method of claim 1, wherein performing the incremental sales analysis includes performing one or more of the following: calculating an incremental change in sales volume, incremental change in sales revenue, and incremental change in sales profit.

6. The method of claim 1, wherein performing the incremental sales analysis includes performing one or more of the following: calculating an incremental change in sales volume, incremental change in sales revenue, and incremental change in sales profit of the promoted product.

7. The method of claim 1, wherein performing the incremental sales analysis includes performing one or more of the following: calculating an incremental change in sales volume, incremental change in sales revenue, and incremental change in sales profit of a product other than the Promoted product.

8. The method of claim 1, wherein the fee is assessed against one or more selected from the group consisting of: advertiser, retailer, and publisher.

9. The method of claim 1, wherein the fee is credited to one or more parties that contributed to the planning and/or execution of the promotion.

10. The method of claim 1, wherein the fee is based on a percentage of the incremental change in sales.

11. The method of claim 1, wherein performing the incremental analysis includes:
assigning to a control group a first subset of a plurality of target customers associated with the promotion;
assigning to an offer group at least a second non-overlapping subset of the plurality of target customers;
providing to at least the offer group but not to the control group an offer associated with the promotion; and
determining an incremental change in sales of the product contributed by the customers in the offer group as compared to sales contributed by the customers in the control group.

12. The method of claim 11, wherein the sales level contributed by the target customers in the control group is compared to a baseline sales level of the target customers in the control group, and wherein the sales level contributed by the target customers in the offer group is compared to a baseline sales level of the target customers in the offer group.

13. The method of claim 11, wherein the sales contributed by each of the target customers is compared to a baseline sales level of that target customer.

14. The method of claim 11, wherein the promotion offer is a type selected from the group consisting of discount coupons and rebates.

15. The method of claim 11, further including randomly assigning <50% of the plurality of target customers to the control group and the remaining of the plurality of target customers to the offer group.

16. The method of claim 11, further comprising identifying the plurality of target customers from a customer pool of a plurality of retailers participating in the promotion.

17. The method of claim 1, further comprising:
receiving a purchase transaction information relating to the promotion, wherein the purchase transaction information identifies purchases made by the target customers in the control group and identifies purchases made by the target customers in the offer group;
wherein determining the incremental increase in sales of the product is based on the purchase transaction information received.

18. The method of claim 17, wherein the purchase transaction information uniquely identifies purchases made by each of the plurality of target customers.

19. The method of claim 17, wherein the purchase transaction information is gathered using one or more methods selected from the group consisting of: scanning or otherwise entering an identifier associated with the promotion offers, customer identifier, credit card, debit card, loyalty card, biometrics, and/or government identification.

20. The method of claim 17, wherein receiving purchase transaction relating to the promotion comprises receiving from one or more point-of-sale computer systems the purchase transaction information relating to the promotion.

21. The method of claim 1, further comprising:
communicating the promotion offer to the target customers in the offer group via a method selected from the group consisting of: direct mail, email, phone message, text message, and point-of-sale print-out.

22. The method of claim 21, wherein each of the promotion offers comprises an identifier uniquely identifying the customer receiving the offer.

23. The method of claim 1, wherein the product being promoted is one of a plurality of products being promoted, the method further comprising for each of the plurality of products being promoted:
assigning to a control group a first subset of the plurality of target customers;
assigning to an offer group at least a second non-overlapping subset of the plurality of target customers;
providing to at least the offer group but not to the control group an offer associated with the promotion; and
determining an incremental change in sales of the product contributed by the customers in the offer group as compared to sales contributed by the customers in the control group for the promotion of the product.

24. The method of claim 23, further comprising for each of the promotion conducted assessing a fee based on the determined incremental change in sales.

25. The method of claim 1, wherein the incremental change in sales is determined based on a maximum allowable discount and an actual discount for individual customers.

26. The method of claim 1, wherein the incremental change in sales due to the promotion is determined based on a difference between a maximum allowable discount and an actual discount for individual customers.

28. The method of claim 1, wherein the incremental change in sales Δπ attributed to the promotion is calculated using the following equation: Δπ=Sₒ*(πₒ/sₒ−π_{c}/S_{c})
where πₒ is the profit for the offer group obtained by calculating the sum of profits of individual transactions in the offer group using the equation πₒ=Σ_{x∈o}uₓ(d^{max}−dₓ), where uₓ(d^{max}−dₓ) is the profit for unit x of the products sold to the offer group and is a function of the difference between the maximum allowable discount per unit of product set by the advertiser, d^{max}, and the actual discount, dₓ, for unit x,
where π_{c}, is the profit for the offer group obtained by calculating the sum of profits of individual transactions in the control group using the equation π_{c}=Σ_{x∈c}uₓ(dₓ), where uₓ(d^{max}) is the profit for unit x of the products sold to the control group and is expressed a function of the maximum allowable discount per unit of product set by the advertiser, d^{max}, and
where Sₒ is the number of shoppers in the offer group and S_{c}is the number of shoppers in the control group.

29. A system, comprising:
an interface configured to communicate with a communications network;
a processor configured to perform the steps of:
performing an incremental sales analysis due to the promotion; and
assessing a fee based on a result of the incremental sales analysis; and
a memory configured to supply the processor with instructions.

30. The system of claim 29, wherein the system is a system for one or more selected from the group consisting of: managing pricing, managing promotion, and managing personalized offers to customers.

31. A computer program product, the computer program product being embodied in computer readable storage medium and comprising computer instructions for execution by a computer processor for performing the steps of:
performing an incremental sales analysis due to the promotion; and
assessing a fee based on a result of the incremental sales analysis.

32. The computer program of claim 31, wherein the computer program product is a computer program product for one or more selected from the group consisting of: managing pricing, managing promotion, and managing personalized offers to customers.
